(19) United States
(12) Patent Application Publication
(10) Pub. No.: US 2007/0007035 A1
(43) Pub. Date: Jan. 11, 2007

(54) Press-fit pins for making electrical contact with vias

(76) Inventors: Alan L. Roath, Madison, OH (US); John T. Venaleck, Painesville, OH (US)

Correspondence Address: Jonathan A. Platt;Renner, Otto, Boisselle & Sklar, LLP, Nineteenth Floor, 1621 Euclid Avenue, Cleveland, OH, 44115, US

(21) Appl. No.: 11/177,564

(22) Filed: Jul. 8, 2005

(51) Int. Cl. H01R 12/06

(52) U.S. Cl. 174/267; 439/82

(57) ABSTRACT

A press-fit pin for making electrical contact with a via is a self-supporting pin having a serpentine shape. The pin may have at least two bends therein, so as to make contact with the via at multiple pairs of contact points separated longitudinally along the length of the pin. This use of a single-member contact with the via may allow use of smaller vias. In a direction longitudinally down the pin, successive pairs of contact points may be on opposite sides of the pin, so as to provide normal forces on opposite sides of the via and the pin, thus tending to provide some degree of balance in forces between the pin and the via. The pin may have rounded, coined corners and a tapered tip, in order to facilitate insertion of the pin into the via, without undue force, and without damage to either the pin or the via.

### BACKGROUND OF THE INVENTION

1. Technical Field of the Invention

The invention relates to the general field of electrical connectors, and in particular to electrical connectors that include pins that couple to conductive vias.

2. DESCRIPTION OF THE RELATED ART

Electrical connection to circuit boards is often made by electrically connecting pins into conductive-material-lined holes in the boards commonly called “vias”. One way of securing the pins within the vias is to solder the pins in place making an electrical connection between the pins and the vias.

Another way of coupling to vias is to use press-fit pins. These are compliant pins that are inserted in the vias, and are maintained mechanically within the vias by normal forces produced by the pins pressing outwardly on the walls of the vias. Two varieties of press-fit pins are the lance type, and the eye-of-the-needle type of pins. Lance type pins involve a pair of protrusions, slightly offset from one another, and perhaps overlapping, that are pressed inward in opposite directions as they are inserted into the vias. An example of lance type pins are those shown in U.S. Pat. No. 4,446,505, where the pins have sections that split into overlapping parts.

In the eye-of-the-needle type pin, the pin splits into a pair of substantially identical, co-planar, sections. The sections form a widened part of the pin. When the pin is inserted into a via, the sections are resiliently pushed toward one another. Examples of eye-of-the-needle type pins may be found in U.S. Pat. Nos. 4,186,892, and 5,564,954.

As the pins of the components that are being attached to the circuit board become smaller, and closer together; the above ways of making electrical contact with the vias become unsuitable. When considering dense pin arrays, soldering becomes more difficult due to bridging and the like. Also, components that have large thermal mass compared to the other components on the circuit board will often demand separate processing, as they will not respond to the solder cycle of the smaller components. Conventional press-fit pins depend on the beam strength of two opposing members inserted into the vias. Below a certain beam strength, the electrical connection is compromised because the forces generated are too small. Also, as the physical dimensions of the beams decrease in order to fit in the via, it becomes increasingly more difficult to manufacture these small pins. Since beam strength is a function of section size to the third power, it becomes immediately obvious that the strength diminishes rapidly as the diameter of the vias decrease. It is, therefore, apparent that a mechanical means of securing electrical pins in small, closely spaced vias wherein the strength of the pin is not compromised, will become valuable.

### SUMMARY OF THE INVENTION

According to an aspect of the invention, an electrical contact includes a press-fit pin that has a serpentine shape.

According to another aspect of the invention, a self-supporting single beam has three points of contact in the via.

Still another aspect of the invention is to provide supporting pairs of pins wherein adjacent pins oppose each other and provide stability requiring only two points of contact in the via, with the overturning moment being opposed by the adjacent contacts through a dielectric carrier. The obvious advantage of this embodiment is that the circuit board thickness can be much less than with the above 3-point contact embodiment.

According to a further aspect of the invention, an electrical contact has a press-fit pin with multiple bends, with pairs of contact points at each of the bends between the pin and a corresponding via into which the pin is inserted. According to a particular embodiment of the invention, the pin has at least three bends.

According to another aspect of the invention, an electrical contact has a press-fit pin with rounded edges that press against a via at multiple points.

According to yet another aspect of the invention, an electrical contact has a press-fit pin with a tapered end, to facilitate insertion into a via.

According to a further aspect of the invention, an electrical contact includes a press-fit pin suitable for engaging vias having diameters of 0.015 inches (0.38 mm) or less.

According to another aspect of the invention, an electrical contact includes a press-fit pin configured to engage a conductive via to make electrical contact with the via. The pin is configured to make a self-supporting single-beam contact with the via. The pin has multiple bends therein along a length of the pin.

According to yet another aspect of the invention, an electrical connection includes: a conductive via; and a press-fit pin in the via, making a single beam connection with the via.

According to still another aspect of the invention, a method of making an electrical connection includes inserting a press-fit pin into a conductive via. The inserting includes making a single beam contact between the pin and the via.

According to a further aspect of the invention, an electrical contact includes a pair of press-fit pins configured to engage respective conductive vias to make electrical contact with the vias. The pins each have a pair of bends spaced along lengths of the pins. The bends of one of the pins are in opposite directions from the bends of the other of the pins. The pins mechanically support one another

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

In the annexed drawings, which are not necessarily to scale:

FIG. 1 is an oblique view of an electrical contact in accordance with the present invention;

FIG. 2 is a plan view of the electrical contact of FIG. 1;

FIG. 3 is a cross-sectional view of the electrical contact of FIG. 1, along the section 3-3 shown in FIG. 2;

FIG. 4 is an oblique view of the electrical contact of FIG. 1, inserted into a via;

FIG. 5 is a cross-sectional view of a first pair of contact points, along section 5-5 in FIG. 4;

FIG. 6 is a cross-sectional view of a second pair of contact points, along section 6-6 of FIG. 4;

FIG. 7 is a cross-sectional view of a third set of contact points, along section 7-7 of FIG. 4;

FIG. 8 is a plan view of a module that includes a plurality of electrical contacts of FIG. 1;

FIG. 9 is a side view of the module of FIG. 8;

FIG. 10 is a cross-sectional view of a board-to-board electrical coupling in accordance with the present invention, utilizing a plurality of the modules of FIGS. 8 and 9;

FIG. 11 is an oblique view of an electrical board, showing an array of vias suitable for use with the electrical coupling of FIG. 10;

FIG. 12 is a cross-sectional view illustrating coupling to a via of a three-bend pin in accordance with the present invention;

FIG. 13 is a cross-sectional view illustrating coupling to vias of a pair of adjacent two-bend pins in accordance with the present invention; and

FIG. 14 is a cross-sectional view illustrating coupling to vias of a pair of opposite two-bend pins in accordance with the present invention.

### DETAILED DESCRIPTION

A press-fit pin for making electrical contact with a via is a self-supporting pin having a serpentine shape. The pin may have at least two bends therein, so as to make contact with the via at multiple pairs of contact points separated longitudinally along the length of the pin. For example, the pin may have at least three bends, with at least three pairs of contact points at three different longitudinal locations of the pin. The pin may make a single-member contact with the via. This use of a single-member contact with the via may allow use of small vias, such as vias less than about 0.020 inches (0.51 mm) in diameter, for example, vias having a diameter of about 0.015 inches (0.38 mm). In a direction longitudinally down the pin, successive pairs of contact points may be on opposite sides of the pin, so as to provide normal forces on opposite sides of the via and the pin, thus tending to provide some degree of balance in forces between the pin and the via. The pin may have rounded, coined corners and a tapered tip, in order to facilitate insertion of the pin into the via, without undue force, and without damage to either the pin or the via. The serpentine press-fit pins may be utilized in any of a wide variety of electrical connectors, including board-to-board connectors for coupling together pairs of circuit boards. The serpentine press-fit pins allow the use of smaller pin sizes, which allow for use of smaller vias, resulting in increased density of vias, and/or increased space between adjacent vias. This increased space allows more room for the routing of traces, which reduces cost by reducing the number of layers required in the board. Use of smaller vias may also result in improved electrical characteristics, with the smaller vias having a lower capacitance which will improve the impedance characteristics of a circuit board that contains the vias. In addition, the press-fit pins will provide good electrical contact with the vias, with contact occurring at multiple contact points. Further, good force characteristics may be obtained by use of the press-fit pins, with balanced normal forces being received on opposite sides of the pin, straightening somewhat the shape of the pin, as the pin is inserted into a via. Because the via need only accept a single beam, unlike present art dual beams, the forces of engagement can be substantially larger and provide better electrical connection for the smaller via sizes.

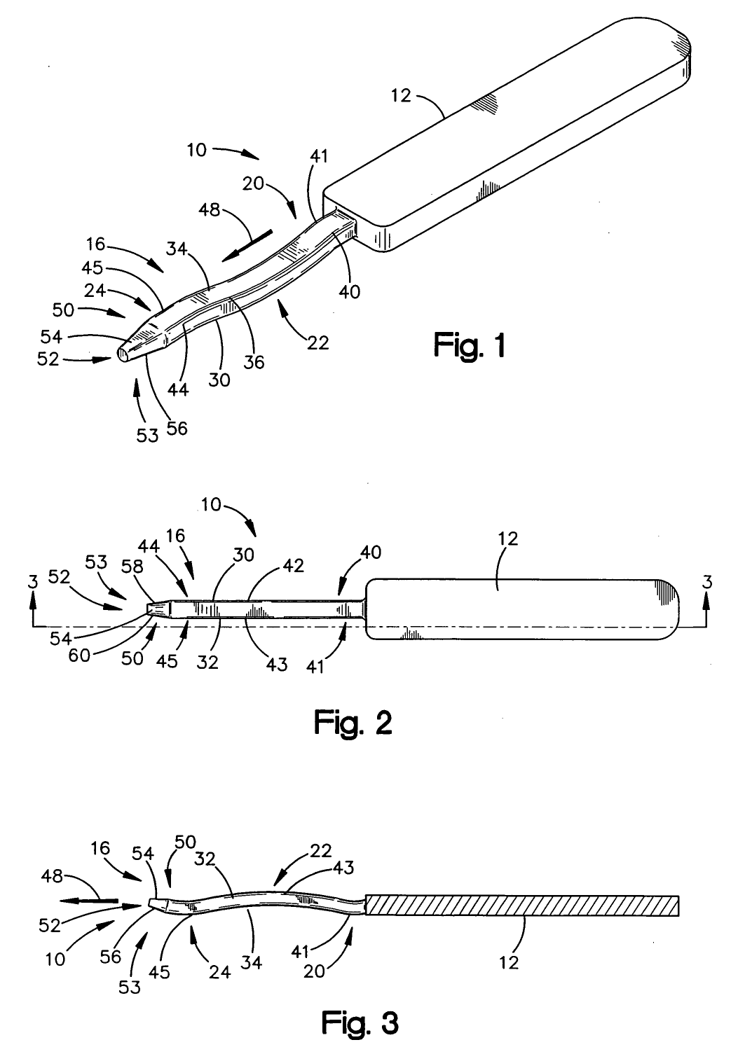

FIGS. 1-3 show an electrical contact 10 that includes a flat paddle of conductive material 12 that terminates into a serpentine self-supporting press-fit pin 16. The pin 16 includes three bends 20, 22, and 24. The bends 20-24 are at different locations along the length of the pin 16, thereby giving the pins 16 an overall serpentine S shape. The bend 22 is in an opposite direction from the bends 20 and 24.

The bends 20, 22, and 24 may (but need not) all have substantially the same radius of curvature, depending on the length of the pin, and the thickness of the board (length of the via) that the connector is pressed into. For example, in one embodiment, the radius of curvature for bends 20 and 24 are in the range of about 0.025 to 0.045 inches (0.64 to 1.14 mm). The radius of curvature of bend 22 in this embodiment is 0.120 to 0.150 inches (3.0 to 3.8 mm). The bends 20, 22, and 24 may be continuously connected, with one of the bends (such as the bend 20) flowing continuously into the next bend (such as the bend 22), without any intervening straight portions.

The press-fit pin 16 is configured to be inserted into a via that has a diameter that is slightly less than the overall height of the pin 16. This causes the pin 16 to be resiliently flattened where it contacts the via, at the bends 20, 22, and 24. This results in contact between the pin 16 and the via at multiple locations along rounded or coined corners 30, 32, 34, and 36, of the pin 16. Thus, there are three pairs of contact points along the pin 16, with contact points 40 and 41 corresponding to the bend 20, contact points 42 and 43 corresponding to the bend 22, and contact points 44 and 45 at the bend 24. The pairs of contact points 40-45 may be located at midpoints of the bends 20, 22, and 24, which may be at longitudinal locations on the length of the pin 16 wherein tangents of the bends 20, 22, and 24 are substantially parallel to an overall length direction 48 of the pin 16. The overall length direction 48 is defined as the direction in which the pin 16 is inserted into a corresponding via. It is equivalent to the direction along the axis of the via.

The tapered tip 52 has a tapered top surface 54 and a tapered bottom surface 56, as well as a pair of tapered side surfaces 58 and 60. The tapered surfaces 54-60 and the coined, rounded edges 30-36 aid in guiding the pin 16 into a via, thereby keeping insertion forces low, and reducing the chance of scoring or other damage to the pin 16 and/or to the via.

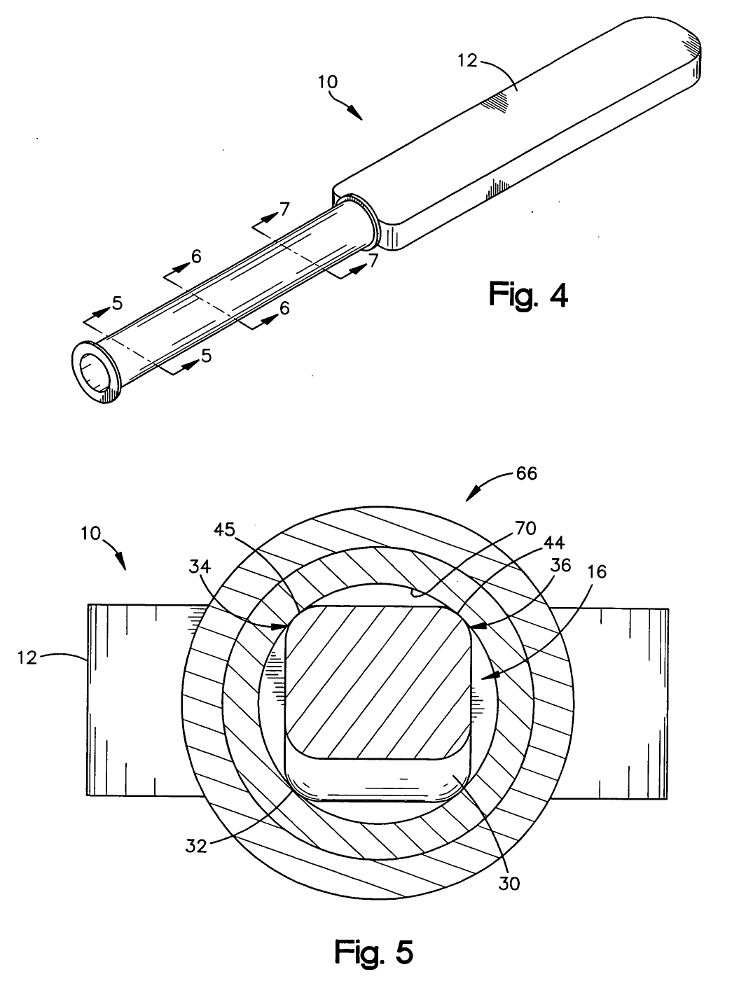

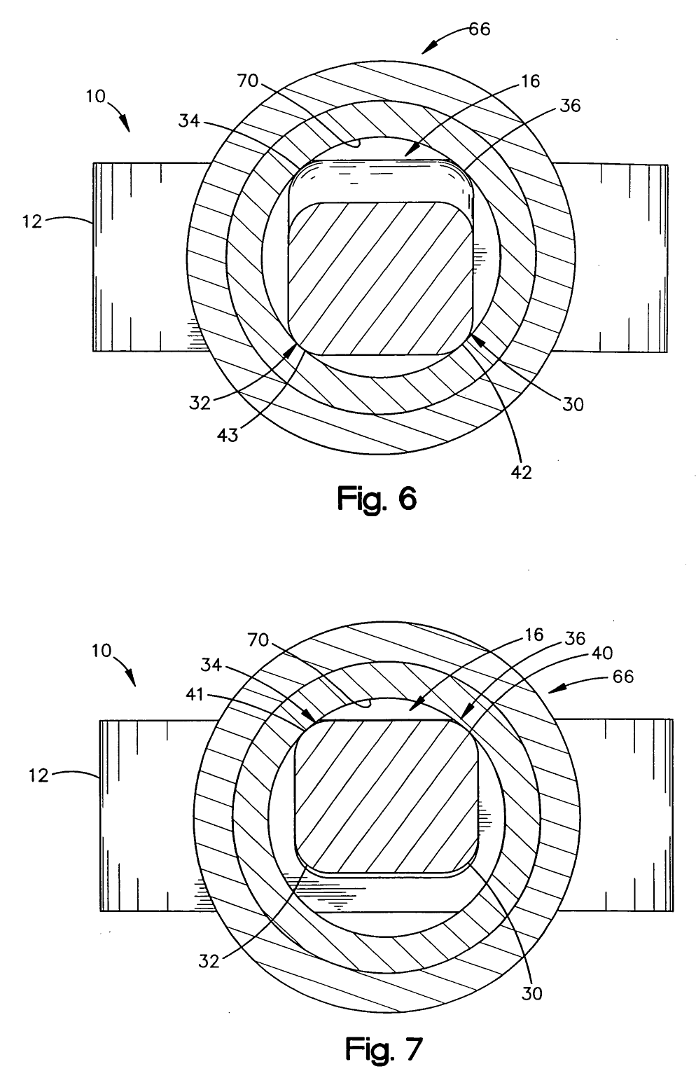

FIG. 4 illustrates insertion of the pin 16 into a via 66. FIGS. 5-7 illustrate the position of the contact points 40-45 along an inner surface 70 of the via 66. The end pairs of contact points 40 and 41, and 44 and 45, are on an opposite side of the via inner surface 70 from the middle contact points 42 and 43. The pin 16 receives normal forces at each of the contact points 40-45. It will be appreciated that the forces at the middle pair of contact points 42 and 43 are opposite to and tend to balance the contact forces at the end pairs of contact points 40 and 41, and 44 and 45.

The electrical contact 10 may be made of any of a variety of suitable materials such as copper alloys, for example, a beryllium copper alloy, or beryllium. Another possible material for the contact 10 is bronze.

The electrical contact 10 may have any of a variety of suitable dimensions. As one example, the flat conductive base or paddle 12 may have a height of 0.010 inches (0.254 mm), the pin 16 may have an overall thickness of about 0.009 inches (0.23 mm), and the pin 16 may have a height from top to bottom of 0.014 inches (0.37 mm). The pin 16 may have a width of about 0.01 inches (0.254 mm). The pin 16 may have a length of about 0.13 inches (3.3 mm). The bends 20 and 24 may be separated by about 0.096 inches (2.44 mm), with the bend 22 located approximately midway between the bends 20 and 24. The tapered tip 52 may taper to a rectangular end about 0.005×0.006 inches (0.127×0.152 mm). As another example, for pins 16 configured to engage vias 66 having a diameter of 0.015 inches (0.38 mm), the pins 16 may have a thickness of about 0.005 to 0.007 inches (0.13 to 0.18 mm).

The via 66 may have a depth slightly less than the length of the pin 16. For example, the via 66 may have a depth of 0.125 inches (3.2 mm), while the pin 16 may have a length of 0.13 inches (3.3 mm).

More broadly, the press-fit pin 16 may be configured to fit a wide range of small-diameter vias, although it will be appreciated that serpentine self-supporting press-fit pins 16 may be configured in a variety of other sizes.

The press-fit pin 16 is a self-supporting pin, able to engage the via 66 on its own. The term self-supporting, as used herein, is defined to mean an electrical contact that does not require an opposing member to establish a normal force high enough to establish a good connection. For example, both lance-type contacts and eye-of-the-needle contacts involve use of identical opposing members, in establishing a sufficient normal force between the contacts and the via into which the contact is inserted. The press-fit pin 16 is a single-beam contact that engages the via 66 on its own.

Having the three bends 20, 22, and 24, and the three corresponding sets of contact points 40 and 41, 42 and 43, and 44 and 45, enables the electrical contact 10 to be held in the via such that the protruding conductive flat paddle 12 stands substantially straight (in line with the axis of the via). This upper portion of the contact is shown here generically as a flat paddle, but could be of any geometry suitable for a specific connector design. This aids in reducing forces necessary to keep electrical connectors that include the electrical contact 10 in place, when they are inserted into a series of vias. Typically this paddle, or upper portion of the contact is molded or pressed into plastic. Because the pin is self supporting, there is essentially no load on the plastic, therefore, the plastic is not required to sustain any significant balancing force required to maintain sufficient contact force of the pin in the via.

The pin 16 engages the via in a single beam connection. A single beam connection is defined as the connection to the via of only a single part within a via, without branching of the single part within the via (as may occur in eye-of-the-needle type prior art connections), and without multiple parts in the via to engage the via (as may occur in lance type prior art connections).

The illustrated embodiment of the contact 10 has the three bends 20, 22, and 24, and the fixed contact points 40-45. It will be appreciated that the pin 16 may be configured to have a greater or lesser number of bends and pairs of contact points.

The pin 16 has a substantially rectangular cross section, with the rounded corners 30-36. It will be appreciated that the pin 16 may alternatively have other suitable cross section shapes, such as an elliptical cross section.

In the illustrated embodiment, the bends 20-24 of the press-fit pin 16 deflect the pin up and down, above and below the plane of the conductive paddle 12. It will be appreciated that other directions for the bends 20-24 are possible, for example, bending the pin 16 from side to side, substantially within the plane of the conductive paddle 12.

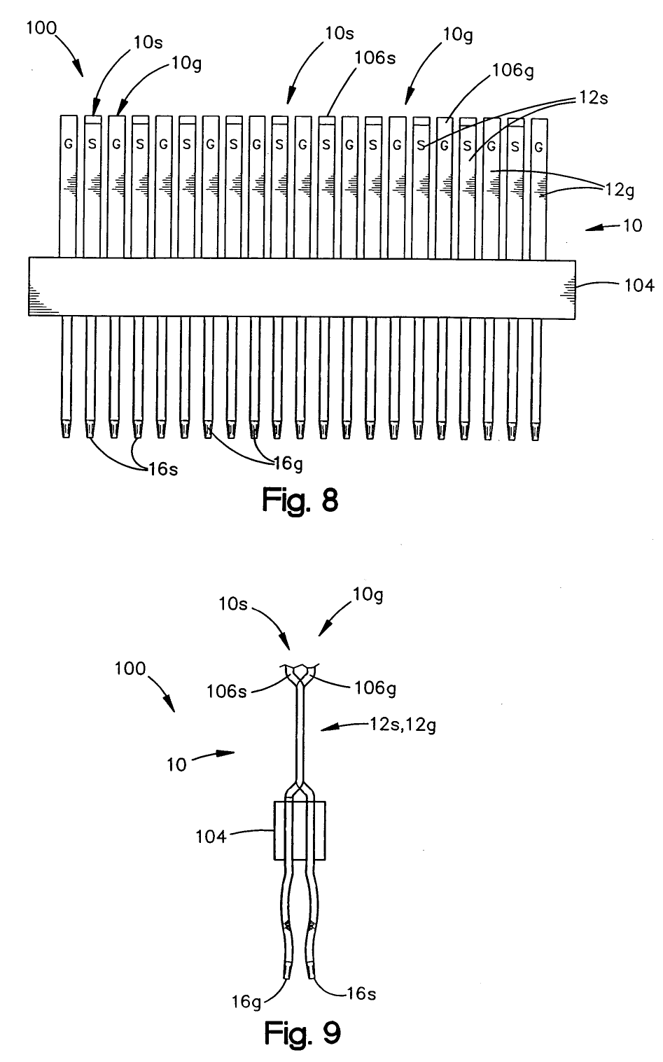

Turning now to FIGS. 8 and 9, a module or wafer 100 is shown that includes a plurality of the electrical contacts 10, secured by a molded-on plastic header 104. The contacts 10 may alternate between signal contacts 10s and ground contacts 10g. The pins 16s of the signal contacts 10s may be arrayed in opposite directions from the ground pin 16g of the ground contact 10g. This staggering of the positions of the pins 16s and 16g allows balancing of insertion forces on the header 104. In addition, the staggering of the pins 16s and 16g allows placement of vias in a diagonal configuration, thus allowing a greater spacing of vias. The conductive paddles are representative of one kind of electrical connector.

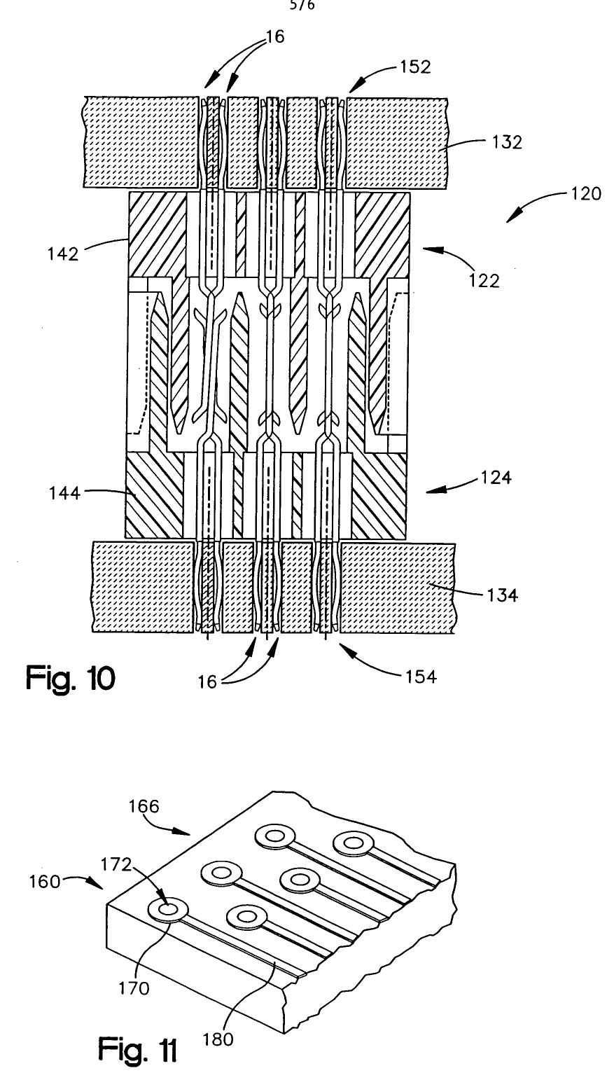

FIG. 10 shows a board-to-board-coupling 120 that includes two mating connectors 122 and 124, electrically coupled to respective boards 132 and 134 through use of press-fit pins 16. Each of the connectors 122 and 124 includes several of the modules 100, details of which are shown in FIGS. 8 and 9. The connectors 122 and 124 also include respective mating housings 142 and 144, which encloses and holds together the modules 100 of each of the connectors 122 and 124. The boards 132 and 134 have respective sets of vias 152 and 154 that are electrically coupled to the pins 16 of the connectors 122 and 124.

It will be appreciated that connectors including the serpentine press-fit pins 16 described above may be used in a wide variety of other situations that involve electrical coupling to vias.

FIG. 11 shows a circuit board 160 with an array of vias 166 for receiving the press-fit pins 16 described above. The vias 166 each include an annular conductive material 170 surrounding a hole 172 lined with conductive material. Conductive traces 180 electrically couple the vias 166 to other components (not shown) on the circuit board 160. As noted above, use of the press-fit pins 16 described above may enable use of smaller-diameter vias on circuit boards. This may allow greater concentration of the vias per unit area of the circuit board 160. Alternatively, or in addition, the amount of space between the annular rings 170 of the vias 166 may be increased, which may facilitate routing of the conductive traces 180. Having more space between adjacent of the vias may reduce the number of conductive trace layers in the board 160.

The press-fit pins 16 described above exhibit many advantageous properties in comparison to certain prior electrical contacts. The pins 16 may be made small (0.01 inches (0.25 mm) or less), enabling use of smaller vias. The pins 16 make contact at different longitudinal points along the via, which may make for better electrical performance, and may allow excess material at a distal end (tip) of the pin 16 to be left in place, without significant adverse effect to electrical performance. The ability to use smaller vias may also result in improved electrical characteristics for the circuit board 160, since smaller vias have lower capacitance, and reducing the capacitance of the vias improves the impedance characteristics of the board 160. Further, the pins 16 allow use of a single-beam engagement with vias, with the pins 16 being self-supporting when inserted in the via, with normal forces from the via maintaining the pin 16 in position. The tapered end 52 and rounded edges 30-36 of the pin 16 also facilitate insertion of the pin 16 into a via.

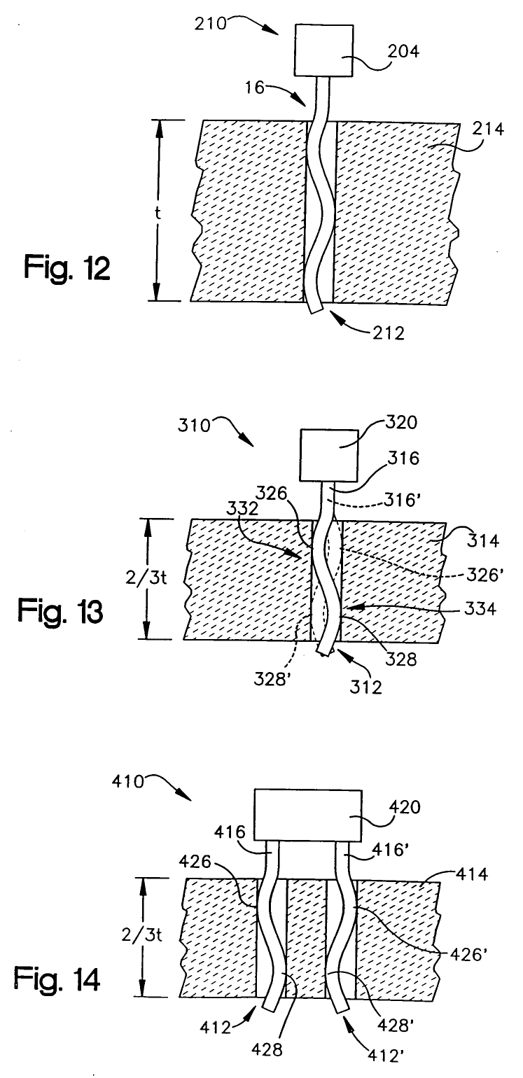

The pin 16 described above is a three-bend pin, with the individual pins able to be substantially self supporting, by having substantially balanced forces on each of the pins 16. However a single beam press-fit pin may also be designed with only two bends and the added support of an adjacent contact, or with two bends and the added support from an opposing contact. FIGS. 12-14 illustrate a three-bend pin, and a pair of configurations utilizing two-bend pins.

FIG. 12 shows a self-supporting three-bend pin 16, such as that described above, connected to a dielectric material header 204 as part of a connector or connector module 210. The pin 16 is self-supporting within a via 212 in a circuit board 214 having a thickness t.

FIG. 13 shows a connector or connector module 310 having one of a pair of adjacent two-bend pins 316, in a via 312 in a circuit board 314. The pin 316 is supported by a dielectric material header 320, and has contact points 322 and 324 at a pair of bends 326 and 328 at respective longitudinal locations 332 and 334. Since the pin 316 has only the two bends 326 and 328, the circuit board 314 may have a thickness that is less than that of the circuit board 214, for example having a thickness of ⅔ t. The header 320 also supports a second pin 316′, shown in FIG. 13 in broken lines behind the first pin 316, in a direction perpendicular to the plane in which the bends 326 and 328 are located. The second pin 316′ is joined to the same dielectric material header 320 as the first pin 316, and is inserted into a separate via in the circuit board 314. The second pin 316′ has its bends 326′ and 328′ in opposite direction from those of the bends 326 and 328 of the first pin 316. Individually, the pins 316 and 316′ have a net force on each of them, but the forces on the pair of the pins 316 and 316′ substantially cancel out, since the pins 316 and 316′ have their pairs of bends in opposite directions.

FIG. 14 shows another variation on the two-bend pin concept, in which a connector or connector module 410 includes a pair of opposing two-bend pins 416 and 416′ secured by a dielectric material header 420. The pins 416 and 416′ are inserted into respective vias 412 and 412′ in a circuit board 414, which has a thickness ⅔ t. The pins 416 and 416′ have respective pairs of bends, 426, 428, and 426′, 428′, in opposite directions from one another. The pins 416 and 416′ are spatially separated in the plane of the bends 426, 428, and 426′, 428′. Since the bends 426 and 428 of the pin 416 are in opposite directions to the bends 426′ and 428′ of the pin 416′, the forces on the pins 416 and 416′ may substantially cancel out, leaving the net force on the pair of pins 416 and 416′ substantially zero.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. An electrical contact comprising:
a press-fit pin configured to engage a conductive via to make electrical contact with the via;
wherein the pin is configured to make a self-supporting single-beam contact with the via; and
wherein the pin has multiple bends therein along a length of the pin.

2. The electrical contact of claim 1, wherein the multiple bends includes three bends separated longitudinally along the length of the pin.

3. The electrical contact of claim 2, wherein each of the bends defines a pair of contact points to engage the via.

4. The electrical contact of claim 3, wherein the contact points of a middle pair of the contact points are on an opposite side of the pin from the contact points of end pairs of contact points that are longitudinally on either side of the middle contact points.

5. The electrical contact of claim 3, wherein the contact points are located longitudinally at locations wherein tangents of the bends are substantially parallel to an overall longitudinal direction along the pin.

6. The electrical contact of claim 1, wherein the pin has a serpentine shape.

7. The electrical contact of claim 1, wherein the pin has a substantially rectangular cross-section.

8. The electrical contact of claim 7, wherein the rectangular cross-section has rounded edges.

9. The electrical contact of claim 1, wherein the pin has a free end with a tapered tip.

10. The electrical contact of claim 1, wherein the pin is configured to engage a via having an inner diameter of less than 0.020 inches.

11. The electrical contact of claim 1, in combination with a conductive via.

12. An electrical connection comprising:
a conductive via; and
a press-fit pin in the via, making a single beam connection with the via.

13. A method of making an electrical connection, the method comprising:
inserting a press-fit pin into a conductive via;
wherein the inserting includes making a single beam contact between the pin and the via.

14. The method of claim 13, wherein the via has an inner diameter of less than 0.020 inches.

15. The method of claim 13,
wherein the pin has a serpentine shape; and
wherein the inserting includes resiliently partially straightening the serpentine shape of the pin.

16. The method of claim 13, wherein the inserting includes making contact between the pin and the via at multiple longitudinally-separated locations along the pin and the via.

17. An electrical contact comprising:
a pair of press-fit pins configured to engage respective conductive vias to make electrical contact with the vias;
wherein the pins each have a pair of bends spaced along lengths of the pins;
wherein the bends of one of the pins are in opposite directions from the bends of the other of the pins; and
wherein the pins mechanically support one another.

18. The electrical contact of claim 17, wherein the pins are configured such that forces from the vias on the pins at least partially cancel each other, thereby making the pins stable and adequately supported.

19. The electrical contact of claim 17, wherein the pins are spaced adjacent to one another, with the pins spaced in a direction substantially perpendicular to a plane of the bends.

20. The electrical contact of claim 17, wherein the pins are spaced opposite one another, with the pins spaced in a direction substantially along a plane of the bends.

21. The electrical contact of claim 17, further comprising a dielectric material header attached to the pins.
